(19) United States
(12) Patent Application Publication
(10) Pub. No.: US 2011/0298204 A1
(43) Pub. Date: Dec. 8, 2011

(54) DOCUMENT SECURITY BY ALIGNING VISIBLE AND HIDDEN MARKS

(75) Inventor: Reiner Eschbach, Webster, NY (US)

(73) Assignee: XEROX CORPORATION, Norwalk, CT (US)

(21) Appl. No.: 12/794,859

(22) Filed: Jun. 7, 2010

(51) Int. Cl. B42D 15/00; B41J 2/00

(52) U.S. Cl. 283/67; 283/85; 347/110

(57) ABSTRACT

A printed document includes a security mark with visible and hidden portions. The document includes a security mark defined by at least one first security mark constituent, at least one second security mark constituent, and at least one third security mark constituent, wherein: (i) each first mark constituent is visible in a first lighting condition and is detectable in a second lighting condition; (ii) each second mark constituent is hidden in the first lighting condition and is detectable in the second lighting condition; (iii) each third mark constituent is visible in the first lighting condition and is hidden in the second lighting condition. The security mark includes at least one of the first security mark constituents located adjacent and aligned with one of the second security mark constituents and one of the third security mark constituents. The location and relative placement of the first, second, and third mark constituents is selected such that cut and paste counterfeiting is hindered. The first lighting condition is visible light and the second lighting condition is IR or UV light.

### BACKGROUND

Security is an important concern in the realm of documents and digital production and/or reproduction of same. Known digital image printing/copying systems produce documents of such high quality that a need has been identified to prevent effective printing/copying of certain documents such as high-value printed items including tickets, financial instruments, security ID badges, and the like. Known techniques include printing the original document in a manner such that it includes a digital “watermark” using only conventional paper and toner or ink. A digital watermark in a broad sense can be defined as information, for example one or more letters, words, symbols or patterns, that is at least partially (preferably fully or at least substantially) hidden in a printed image under normal viewing conditions but that is more clearly discernable under certain specialized viewing conditions. Unauthorized reproduction of documents including such digital watermarks typically degrades or obscures the digital watermark, which can aid in detection of counterfeit documents.

A fluorescence or UV mark is one example of a known digital watermark. Methods and systems are known for including fluorescence marks in printed documents using conventional papers (e.g., ordinary “copy paper” or “printer paper”) and ordinary inks/toners (e.g., CMYK ink/toner), specifically by using metameric colorant mixtures. Under visible lighting conditions (e.g., electromagnetic radiation wavelengths of about 390-700 nanometers (nm)), the different colorant mixtures that are printed on respective adjacent portions of the paper together define an overall printed document region that appears substantially uniform in color. Under ultraviolet (UV) lighting (e.g., electromagnetic radiation wavelengths shorter than about 390 nm), these different colorant mixtures exhibit different UV absorption and, thus, different suppression of UV fluorescence of the optical brightening agents used in conventional printing/copying papers such that the region printed with the colorant mixture that suppresses less of the substrate fluorescence appears as a lighter/brighter region while the adjacent area printed with the colorant mixture that strongly suppresses substrate fluorescence appears as a darker region. These contrast variations under UV lighting are used to create watermark-like patterns, e.g., numbers, letters, symbols, shapes, that can be observed with the naked eye.

Likewise, methods and systems are known for including infrared (IR) marks in printed documents using conventional papers and ordinary inks/toners (e.g., CMYK ink/toner) by using metameric colorant mixtures. Under visible lighting conditions, the different colorant mixtures that are printed on respective adjacent portions of the paper together define an overall printed document region that appears substantially uniform in color. Under infrared (IR) lighting (e.g., electromagnetic radiation wavelengths longer than 700 nm but shorter than microwaves), these different colorant mixtures exhibit different IR absorption/transmission and, thus, different suppression of IR reflectance from the paper or other substrate on which the colorants are printed. The region printed with the colorant mixture that absorbs less (transmits more) IR appears as a lighter/brighter region while the adjacent area printed with the colorant mixture that absorbs more (transmits less) IR appears as a darker region. These contrast variations under IR lighting are used to create watermark-like patterns, e.g., numbers, letters, symbols, shapes, that can be observed using an IR camera or other IR sensor/imaging device.

An example of the above is shown in FIG. 1, wherein a colorant mixture “B” is selected and applied to patch area BP which, in this example, is shaped as the alphanumeric symbol “0”. Further, a colorant mixture “A” is selected and applied to patch area AP arranged here in substantially close spatial proximity to patch area BP, and thereby providing a background around patch area BP. The patch areas AP and BP together define a security mark region SMR. Both colorant mixture A and colorant mixture B are comprised of one or more suitably selected colorants, but colorant mixtures A and B are different mixtures. Each colorant mixture A or B may be, for example, either a single CMYK colorant or any mixture of CMYK colorants. In the illustrated example, the colorant mixtures A and B are selected as follows:
(i) in the case of a UV mark, colorant mixture A is selected to provide greater substrate coverage and greater substrate fluorescence suppression as compared to colorant mixture B;
(ii) in the case of an IR mark, colorant mixture A is selected to provide greater IR absorption (less IR transmission) and greater substrate IR reflectance suppression as compared to colorant mixture B.
   The colorant mixtures A and B will also be selected to match each other closely in their average color and luminance when viewed under visible light conditions. As shown at IR/UV in FIG. 1, under UV lighting conditions (for a UV mark) or under IR lighting conditions (for an IR mark), patch BP will appear brighter as compared to patch AP to define a security mark SM, due to the relatively limited suppression of the fluorescence of the optical brightening agents in the paper substrate in region BP as compared to the patch AP (for a UV mark) or due to the relatively high transmission of IR in the region BP leading to an increased IR reflectance from the paper substrate (for an IR mark). In contrast, under visible light conditions as shown at VIS, patches AP,BP are at least substantially indistinguishable. This property of matching color under a first lighting condition (e.g., visible light) but unmatched color under a second lighting condition (e.g., IR or UV light) is referred to as metamerism and the colorant mixtures A and B can be said to define a metameric or approximately metameric pair.

Additional details and variations relating to fluorescence marks are disclosed in U.S. patent application Ser. No. 11/382,897 filed May 11, 2006 in the name of Raja Bala and Reiner Eschbach and entitled “Substrate Fluorescence Mask for Embedding Information in Printed Documents” and U.S. patent application Ser. No. 11/382,869 filed May 11, 2006 in the name of Raja Bala and Reiner Eschbach and entitled “Substrate Fluorescence Pattern Mask for Embedding Information in Printed Documents” and the disclosures of both these applications are hereby expressly incorporated by reference into the present specification. Additional details relating to infrared marks are disclosed in U.S. patent application Ser. No. 11/758,359 filed Jun. 5, 2007 in the name of Reiner Eschbach, Raja Bala, and Martin Maltz and entitled “Infrared Encoding of Security Elements Using Standard Xerographic Materials with Distracting Patterns” and in U.S. patent application Ser. No. 11/758,344 filed Jun. 5, 2007 in the name of Reiner Eschbach, Raja Bala, and Martin Maltz and entitled “Infrared Encoding of Security Elements Using Standard Xerographic Materials” and in U.S. patent application Ser. No. 12/106,709 filed Apr. 21, 2008 in the name of Reiner Eschbach and Martin Maltz and entitled “Infrared Watermarking of Photographic Images by Matched Differential Black Strategies” and the disclosures of these prior applications are also hereby expressly incorporated by reference into the present specification.

With security marks as described above, it is sometimes convenient for a counterfeiter to create a counterfeit document by cutting and pasting a security mark from a genuine document into a counterfeit document. This cut and paste operation can relate to physical documents (cutting and pasting paper documents or the like) or can relate to electronic documents for which image processing software is used to cut and paste one document portion into another document. As such, it has been deemed desirable to provide a security mark such as an IR mark or a UV mark that makes such cutting and pasting operations unduly complicated and time consuming to diminish the value and decrease the use of such counterfeiting operations.

### SUMMARY

In accordance with a first aspect of the present development, a printed document includes a security mark with visible and hidden portions. The document includes a security mark defined by at least one first security mark constituent, at least one second security mark constituent, and at least one third security mark constituent, wherein: (i) each first mark constituent is visible in a first lighting condition and is detectable in a second lighting condition; (ii) each second mark constituent is hidden in the first lighting condition and is detectable in the second lighting condition; (iii) each third mark constituent is visible in the first lighting condition and is hidden in the second lighting condition. The security mark includes at least one of the first security mark constituents located adjacent and aligned with one of the second security mark constituents and one of the third security mark constituents.

In accordance with another aspect of the present development, a method for providing a document including a security mark includes defining a security mark using a first security mark constituent, a second security mark constituent, and a third security mark constituent, wherein: (i) each first mark constituent is visible in a first lighting condition and is detectable in a second lighting condition; (ii) each second mark constituent is hidden in the first lighting condition and is detectable in the second lighting condition; (iii) each third mark constituent is visible in the first lighting condition and is hidden in the second lighting condition. The security mark includes at least one first security mark constituent located adjacent and aligned with one of said second security mark constituents and one of said third security mark constituents. The method further includes arranging the security mark in an electronic file that defines a document to be printed, outputting the electronic file to a printer, and using the printer to print the document.

In accordance with another aspect of the present development, a method of determining if a document is counterfeit includes viewing the document in a first lighting condition and viewing the document in a second lighting condition. The first appearance of the document in the first lighting condition is compared to the second appearance of the document in the second lighting condition, wherein the step of comparing includes identifying (i) a first security mark constituent that is visible in the first lighting condition and that is detectable in a second lighting condition; (ii) a second security mark constituent that is hidden in the first lighting condition and that is detectable in the second lighting condition; (iii) a third security mark constituent that is visible in the first lighting condition and that is hidden in the second lighting condition; and, (iv) a region where a first security mark constituent is located adjacent and is aligned with both a second security mark constituent and a third security mark constituent.

### BRIEF DESCRIPTION OF DRAWINGS

FIG. 1 (prior art) diagrammatically discloses the inclusion of an IR or UV security mark in a printed document;

FIG. 2 illustrates three different types of security mark constituents used to provide a document including a security mark with visible and hidden portions in accordance with the present development;

FIG. 3A illustrates use of the security mark constituents of FIG. 2 to define a security mark in accordance with the present development, including visible and hidden portions as viewed in visible light;

FIG. 3B shows the security mark of FIG. 3A as detected when it is illuminated by an IR source or UV source;

FIG. 4 is a flow chart illustrating one method for providing a printed document including a security mark with aligned visible and hidden portions;

FIG. 5A illustrates a document printed in accordance with the present development to include a security mark with visible and hidden portions, as the document appears in visible light;

FIG. 5B illustrates the document of FIG. 5A as detected when it is illuminated by an IR source (and viewed using an IR camera) or when it is illuminated by a UV source (and viewed with the naked eye);

FIGS. 6A and 6B correspond respectively to FIGS. 5A and 5B, but show a counterfeit document;

FIG. 7 illustrates an apparatus suitable for implementing a method in accordance with the present development.

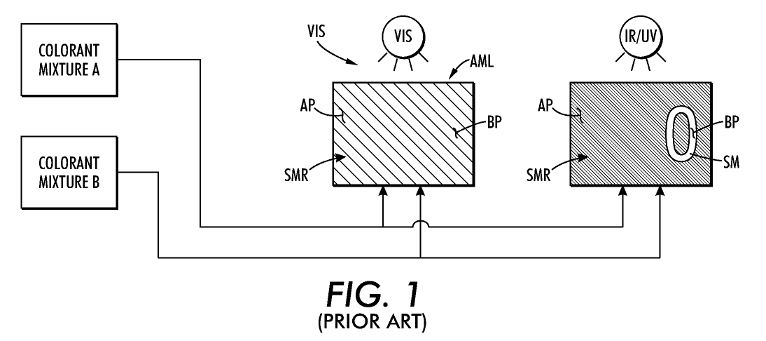

### DETAILED DESCRIPTION

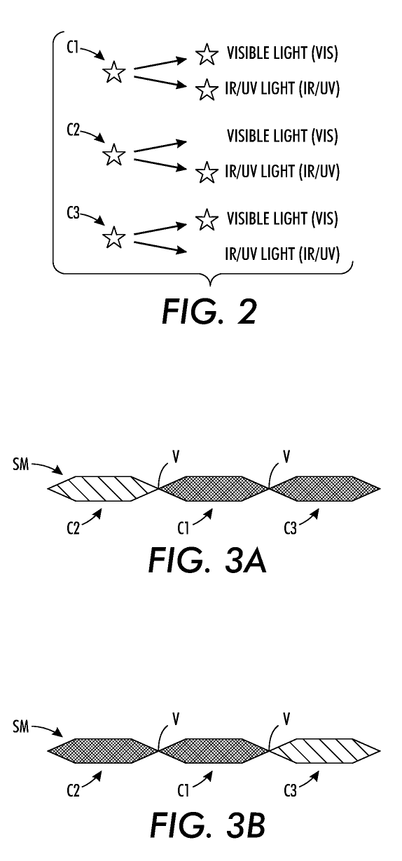

FIG. 2 illustrates three different types of security mark constituents C1,C2,C3 used to provide a printed document including a security mark with visible and hidden portions in accordance with the present development. Also, as used herein, the term “visible” means at least substantially visually apparent to a human viewer with the naked eye, the term “detectable” means at least substantially visually apparent to a human viewer with the naked eye or visually perceptible to a human viewer through a sensing device such as an IR camera or other sensing device, and the term “hidden” means not “detectable,” i.e., at least substantially invisible or obscured beyond recognition to a human viewer with a naked eye or using a sensing device such as an IR camera or other sensing device. The term “UV light” or “UV source” means a source of UV light/radiation as described above, and the term “IR light” or “IR source” means a source of IR light/radiation as described above. It is understood that the appropriate viewing apparatus is also to be used. For UV light, an unaided eye is normally sufficient, whereas for an IR source an IR camera/detector is needed converting the IR signal into a visible signal. Such devices are commonly available. With that in mind, the first, second, and third mark constituents C1,C2,C3 have the following properties as shown in FIG. 2:

### First Mark Constituent C1

C1 (visible light)=visible
C1 (IR/UV source)=detectable

### Second Mark Constituent C2

C2 (visible light)=hidden
C2 (IR/UV source)=detectable

### Third Mark Constituent C3

C3 (visible light)=visible
C3 (IR/UV source)=hidden

In a more general sense:
the first mark constituent C1 is visible in a first lighting condition (when subjected to a visible light) and is detectable in a second lighting condition (when subjected to an IR source (for an IR mark) or a UV source (for a UV mark));
the second mark constituent C2 is hidden in a first lighting condition (visible light) but is detectable in a second lighting condition (IR source (for an IR mark) or UV source (for a UV mark)); and,
the third mark constituent C3 is visible in a first lighting condition (visible light) and is hidden in a second lighting condition (IR source (for an IR mark) or UV source (for a UV mark)).

Although the first, second, and third mark constituents C1,C2,C3 are shown as identical shapes, they can each have their own shape and size as desired. It is important, however, that the shape/size selected for each be such that registration or alignment (or lack of registration/alignment) between adjacent individual mark constituents C1,C2,C3 be readily apparent when viewed or detected by a human observer.

These properties of the security mark constituents are exploited to provide a printed document that is resistant to counterfeiting by physical or electronic/software cut and paste operations. FIG. 3A illustrates use of the security mark constituents of FIG. 2 to define a security mark SM in accordance with the present development, including visible and hidden portions as viewed in visible light. It can be seen that the security mark constituents C1,C2,C3 (shown as oblong hexagons) are arranged with their adjacent vertices V touching or registered with each other so that the security mark constituents are arranged in a straight line. The mark constituent C2 is shown with cross-hatching to indicate that it is hidden in visible light. FIG. 3B shows the same security mark SM as detected when subjected to IR lighting from an IR source or when subjected to UV lighting from a UV source, and it is apparent that the mark constituent C3 becomes hidden (as indicated with cross-hatching) while the mark constituent C2 becomes detectable. The mark constituent C1 is visible in visible light (FIG. 3A) and is also detectable in IR/UV light (FIG. 3B).

Those of ordinary skill in the art will recognize from FIGS. 3A and 3B that a security mark SM defined in accordance with the present development using all of the mark constituents C1,C2,C3 arranged in a defined pattern and registered or aligned with each other greatly hinders the ability to counterfeit a document using cut and paste operations, i.e., physical cutting and pasting of printed documents or software cutting and pasting of electronic documents. In particular, a cut and paste operation performed in visible light by physical cutting and pasting or by visible light imaging/scanning the document to perform a software/electronic cut and paste operation will not account for the presence and location of the hidden mark constituent C2 which will result in a defective cut and paste operation due to missing mark constituents and/or misalignment between mark constituents that will become apparent when the document is viewed in IR/UV light. Likewise, a cut and paste operation performed in IR/UV light by physical cutting and pasting or by IR/UV imaging/scanning the document to perform a software/electronic cut and paste operation will not account for the presence and location of the hidden mark constituent C3 which will also result in a defective cut and paste operation due to missing mark constituents and/or misalignment between mark constituents which will become apparent with the document is viewed in IR/UV light.

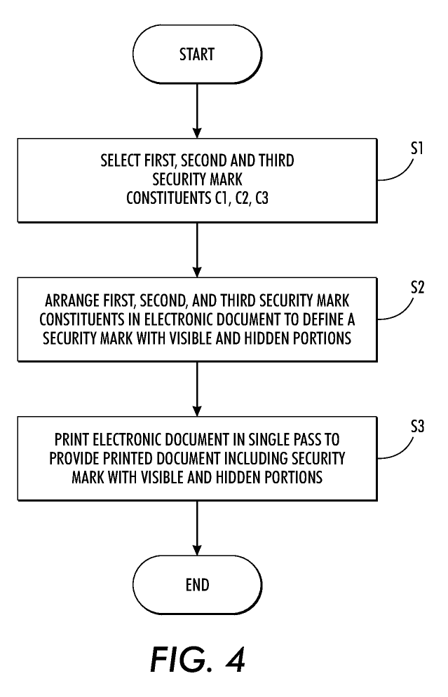

FIG. 4 is a flow chart illustrating one method for providing a printed document including a security mark with aligned visible and hidden portions. In a step S1, the first, second, and third security mark constituents C1,C2,C3 are selected so as to have the above-noted properties. In a step S2, the first, second, and third security mark constituents are arranged in an electronic document to define the electronic document to include a security mark. In particular, the security mark defined by the security mark constituents C1,C2,C3 should have at least one location where a first mark constituent C1 is located adjacent and is aligned with both a second mark constituent C2 and a third mark constituent C3, e.g., as shown in FIGS. 3A and 3B where with the first mark constituent C1 is located adjacent and between the second and third mark constituents C2,C3. Such an arrangement makes it difficult for a counterfeiter to produce a counterfeit document in which alignment and proper adjacency of the mark constituents C1,C2,C3 is preserved. As described further below, it is also desirable that the security mark include at least one second or third mark constituent C2,C3 that straddles a border defined between first and second regions of the document that include different types or appearances of content, e.g., a border between a text region and a photograph or other image region of the document, a border between first and second different images, a border between first and second text regions of the document that use different font types/sizes/colors, etc., because such borders between regions of different content types/appearances provide natural cut and paste boundaries that are locations where a counterfeiter will perform cut and paste operations, and the presence of a second or third mark constituent C2,C3 straddling the border will render such a cut and paste operation difficult to complete and/or more easily detectable.

In a step S3, the electronic document is printed on paper or other substrate in a single printing pass to provide a printed document including a security mark with visible and hidden portions.

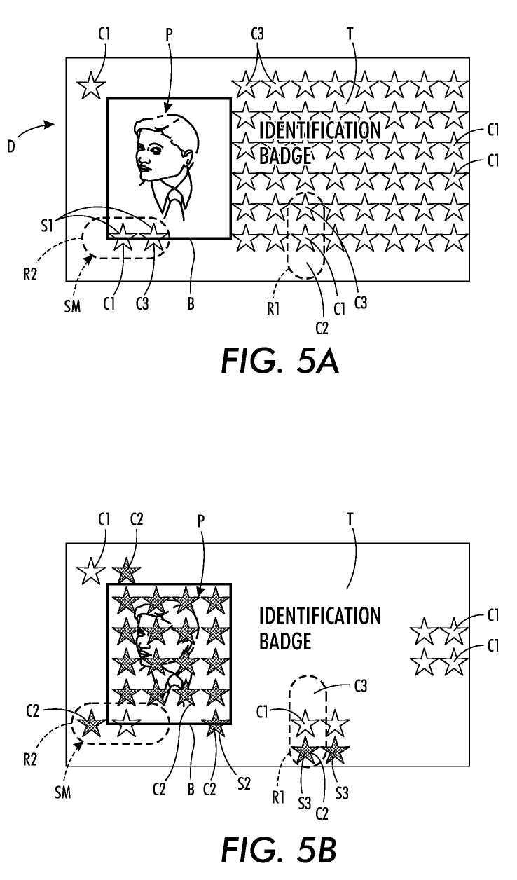

FIGS. 5A and 5B illustrates an example of the method of FIG. 4. The printed document D is an identification badge including a photograph portion P and a text portion T separated by a border B. The document D was printed in a single pass. In FIG. 5A, the document D is shown as it appears when illuminated in visible light, where it can be seen that the document D includes first mark constituents C1 (always visible/detectable) and third mark constituents C3 (visible/detectable only in visible light). FIG. 5B shows the document D when illuminated using an IR source or UV source as detected using a camera (in the case of the IR source) or as visualized with the naked eye (in the case of a UV source). In FIG. 5B, it can be seen that the document D also includes second mark constituents C2 (visible/detectable only in IR/UV). The mark constituents C1,C2,C3 are arranged so that they are aligned with each other in rows and columns, and so that adjacent vertices of adjacent constituents C1,C2,C3 touch or are close to each other and are in alignment or registered. Also, some of the mark constituents C2,C3 straddle the border B between the text portion T and photograph portion P. It is preferred that one of said first security mark constituents C1 be located adjacent and aligned with (e.g., between) one of said second security mark constituents C2 and one of said third security mark constituents C3 as shown in FIGS. 3A and 3B (and as is also the case in FIGS. 5A and 5B), because this situation makes it difficult for a counterfeiter to perform a cut and paste operation while maintaining the proper alignment of the mark constituents C1,C2,C3 in both the first and second lighting conditions. Such regions are shown at R1 and R2.

The document D thus includes a security mark SM including visible portions and hidden portions, and the definition of these portions changes depending upon whether the document D is subjected to a first lighting condition (visible light FIG. 5A) or a second lighting condition (IR or UV light FIG. 5B). In visible light (FIG. 5A), the mark constituents C1 and C3 provide the visible portion and the mark constituents C2 provide the hidden portion. In IR or UV light (FIG. 5B), the mark constituents C1 and C2 provide the visible portion and the mark constituents C3 provide the hidden portion. The printed document D thus includes a security mark SM that exhibits a first select or predetermined appearance in a first lighting condition (visible light) and exhibits a second select or predetermined appearance in a second lighting condition (IR or UV lighting). For example, in the first lighting condition (FIG. 5A), the text portion T of document D includes a full and uniform background of stars behind the words “IDENTIFICATION BADGE” (defined by third mark constituents C3 in the present example) and the document D includes stars S1 (defined by first and third mark constituents C1,C3 in the present example) that straddle the border between the photograph portion P and the text portion T. Region R1 includes vertically aligned and adjacent first, second, and third mark constituents C1,C2,C3 (mark constituents C2 are not visible in FIG. 5A). Region R2 includes horizontally aligned and adjacent first, second, and third mark constituents C1,C2,C3 (mark constituents C2 are not visible in FIG. 5A). It should be recognized that region R2 corresponds exactly to FIGS. 3A and 3B.

In the second lighting condition (FIG. 5B), the background B behind the words “IDENTIFICATION BADGE” is devoid of stars, and one of the stars S1 straddling the border is missing, while a new star S2 (defined by a second mark constituent C2) is apparent and straddles the border between the photograph portion P and the text portion T. New stars S3 also become visible in the second lighting condition.

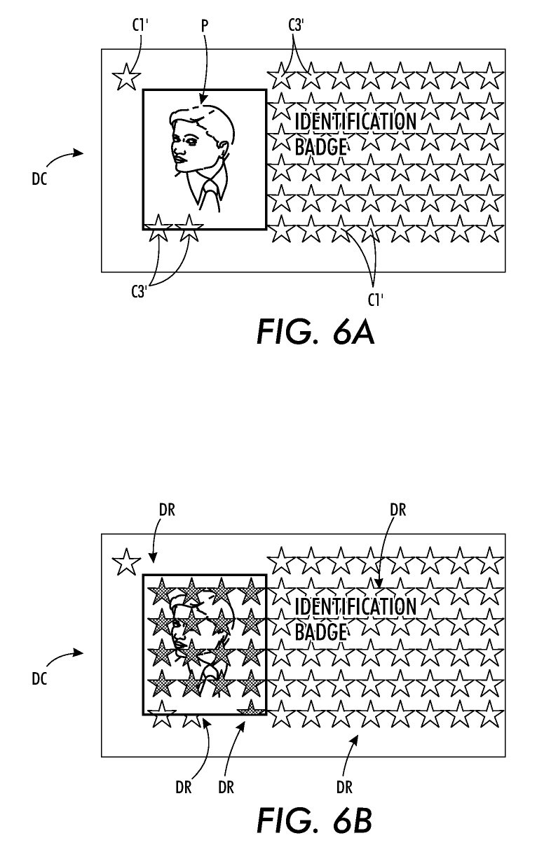

FIGS. 6A and 6B correspond respectively to FIGS. 5A and 5B, but show a counterfeit document DC created by cutting the photograph portion P from the genuine document D and pasting it into another document created to have a text portion T that appears to match the genuine document D shown in FIG. 5A. It can be seen that in visible light (FIG. 6A) the counterfeit document DC appears to be genuine and includes what appear to be first and third mark constituents (shown at C1′ and C3′). In IR or UV light (FIG. 6B), however, the document DC is detected to be a counterfeit, because the counterfeit third mark constituents C3′ do not disappear and certain required second mark constituents C2 do not appear in the counterfeit text portion T. This leads to defect regions DR where mark constituents are present or not present or partially present in error. The counterfeit document DC can thus be detected.

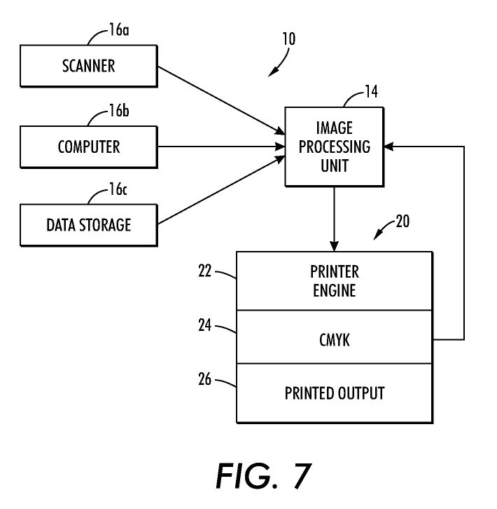

The system and method in accordance with the present development are preferably implemented in an image processing and printing system such as any commercially available multi-colorant (“color”) printer, which can be provided as part of a printing and/or reproduction apparatus. Typically, the printer implements a CMYK color space and includes a xerographic printer engine although the present development is applicable to other printing methods such as ink-jet, solid-ink (SIJ), gel-ink, etc. FIG. 7 illustrates one example of an apparatus for implementing a method in accordance with the present development. The apparatus 10 comprises an image processing unit (IPU) 14 for carrying out the digital image processing operations disclosed herein. The IPU 14 is defined by electronic circuitry and/or software that is dedicated to digital image processing and/or can comprise a general purpose computer programmed to implement the image processing operations disclosed herein. The IPU 14 is adapted to receive image data from a source such as a scanner 16a, computer 16b (e.g., a digital front-end (DFE)), and/or data storage 16c or another source that is part of the apparatus 10 and/or that is operably connected to the IPU 14 through a network or other means. For example, in one embodiment, the IPU 14 receives from the computer 16b data that define an electronic document to include a security mark as described herein. The apparatus 10 comprises an image output or printing unit 20 including a xerographic, ink-jet, or other print engine 22 for printing the image data on paper or another recording medium using the CMYK or other multi-colorant color space 24. The printer unit 20 further comprises a printed output station 26 for physical output of the final printed product such as printed paper or other recording media sheets. Examples of suitable commercially available systems 10 include, but are not limited to, the Phaser™, WorkCentre™, DocuCotor™, iGenr™ and iGen4™ printing/copying/digital press systems available from Xerox Corporation.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A printed document including a security mark with visible and hidden portions, said document comprising:
a security mark defined by at least one first security mark constituent, at least one second security mark constituent, and at least one third security mark constituent, wherein:
each first mark constituent is visible in a first lighting condition and is detectable in a second lighting condition;
each second mark constituent is hidden in the first lighting condition and is detectable in the second lighting condition;
each third mark constituent is visible in the first lighting condition and is hidden in the second lighting condition;
said security mark including at least one of said first security mark constituents located adjacent and aligned with one of said second security mark constituents and one of said third security mark constituents.

2. The printed document as set forth in claim 1, wherein the first, second and third security mark constituents are printed such that the first lighting condition is visible light and the second lighting condition is IR or UV light.

3. The printed document as set forth in claim 2, wherein said first, second, and third security mark constituents are arranged in said printed document relative to each other such that the security mark exhibits a first select appearance in said first lighting condition and exhibits a second select appearance in said second lighting condition.

4. The printed document as set forth in claim 3, wherein said first security mark constituent is located between said second and third security mark constituents, and wherein respective vertices of the first, second, and third security mark constituents are adjacent and aligned with each other.

5. The printed document as set forth in claim 4, wherein said document includes first and second content regions, and wherein at least one of said second and third security mark constituents straddles a border between the first and second different content regions.

6. The printed document as set forth in claim 5, wherein said first and second different content regions comprise a text region and a photograph region.

7. The printed document as set forth in claim 1, wherein said first, second, and third security mark constituents are defined only by CMYK colorants deposited on paper.

8. A method for providing a document including a security mark, said method comprising:
defining a security mark using a first security mark constituent, a second security mark constituent, and a third security mark constituent, wherein: (i) each first mark constituent is visible in a first lighting condition and is detectable in a second lighting condition; (ii) each second mark constituent is hidden in the first lighting condition and is detectable in the second lighting condition; (iii) each third mark constituent is visible in the first lighting condition and is hidden in the second lighting condition;
wherein the security mark includes at least one first security mark constituent located adjacent and aligned with one of said second security mark constituents and one of said third security mark constituents;
arranging said security mark in an electronic file that defines a document to be printed;
outputting said electronic file to a printer and using said printer to print said document.

9. The method as set forth in claim 8, wherein said printer prints said document in a single pass.

10. The method as set forth in claim 8, wherein the first, second and third security mark constituents are defined such that the first lighting condition is visible light and the second lighting condition is IR or UV light.

11. The method as set forth in claim 10, wherein said first, second, and third security mark constituents are arranged to define said security mark such that the security mark exhibits a first select appearance in said first lighting condition and exhibits a second select appearance in said second lighting condition.

12. The method as set forth in claim 11, wherein said step of arranging said first, second and third security mark constituents comprises locating said first security mark constituent between said second security mark constituent and said third security mark constituent.

13. The method as set forth in claim 12, wherein said step of arranging said first, second and third security mark constituents further comprises locating at least one of said second and third security mark constituents so as to straddle a border located between first and second regions of the document that contain different types or appearance of content.

14. The method as set forth in claim 13, wherein the first and second regions comprise a text region and a photograph region.

15. A method of determining if a document is counterfeit, said method comprising:
viewing said document in a first lighting condition;
viewing said document in a second lighting condition;
comparing a first appearance of the document in the first lighting condition to a second appearance of the document in the second lighting condition, wherein said step of comparing includes identifying:
a first security mark constituent that is visible in the first lighting condition and that is detectable in a second lighting condition;
a second security mark constituent that is hidden in the first lighting condition and that is detectable in the second lighting condition;
a third security mark constituent that is visible in the first lighting condition and that is hidden in the second lighting condition;
a region where a first security mark constituent is located adjacent and is aligned with both a second security mark constituent and a third security mark constituent.

16. The method as set forth in claim 15, wherein the first lighting condition is visible light and the second lighting condition is IR light, and wherein the step of comparing comprises using an IR camera to examine said document in said second lighting condition.

17. The method as set forth in claim 15, wherein the first lighting condition is visible light and the second lighting condition is UV light, and wherein the step of comparing comprises a naked eye examination of said document in both said first and second lighting conditions.

18. The method as set forth in claim 15, wherein said step of comparing further includes:
identifying one of said first security mark constituents located between and aligned with both one of said second security mark constituents and one of said third security mark constituents.

19. The method as set forth in claim 18, wherein said step of comparing further includes:
identifying one of said second security mark constituents or one of said third security mark constituents that is located to straddle a border between first and second different content regions of the document.

20. The method as set forth in claim 19, wherein the first and second contact regions comprise a text region and an image region.
